(19) United States
(12) Patent Application Publication
(10) Pub. No.: US 2014/0230257 A1
(43) Pub. Date: Aug. 21, 2014

(54) HAND HELD DEVICE

(71) Applicant: THE GILLETTE COMPANY, BOSTON, MA (US)

(72) Inventors: CHRISTOPHER RAYMOND EAGLETON, DEVIZES (GB); ANDREW ANTHONY SZCZEPANOWSKI, NORTH ATTLEBORO, MA (US)

(73) Assignee: THE GILLETTE COMPANY, BOSTON, MA (US)

(21) Appl. No.: 14/156,698

(22) Filed: Jan. 16, 2014

Related U.S. Application Data
(60) Provisional application No. 61/766,928, filed on Feb. 20, 2013.

(51) Int. Cl. B26B 21/52

(52) U.S. Cl. CPC B26B 21/522; B26B 21/528
USPC 30/526; 29/401.1

(57) ABSTRACT

A hand held device with a handle comprising a gripping portion which includes a substrate which is retained in a retaining member such that the substrate can be changed during use or manufacturing without impacting the rest of the handle. Preferably, the substrate comprises an elastomeric material, and can even consist essentially of such an elastomeric material.

### BACKGROUND OF THE INVENTION

Shaving hand held device typically include a head unit head and a handle which releasably or permanently attaches to the head unit at one end. Hand held device handles are typically rigid elongated rods. Recently, many hand held devices have been described to hold batteries, electronic components, as well as sachets and so forth, contributing to the hand held device handles becoming larger and longer. See for example the Schick Hydro Silk Power Select hand held device and the Gillette ProGlide Styler trimmer. See e.g. U.S. D644789 and U.S. Patent Publication No. 2011/0219620. These hand held devices, like the majority of hand held devices in the market rely on elongated rigid handles.

Although many razor handles are made of metal and/or plastic, the addition of softer gripping materials to the exterior of the razor have also been disclosed. See e.g. U.S. Pat. Nos. 7,975,389; 7,874,076. 5,497,551. These handles, however, merely add an external surface layer of the gripping material to an otherwise rigid metal or plastic handle. Although the addition of the grip material can help with gripping and surface feel, most handles remain rigid and have an elongated shape.

Hand held devices with differently shaped handles have also been described. For example handles having elongated oval shaped handles have been described and marketed. See e.g. U.S. D349242, U.S. D363142, U.S. D364707, and U.S. D381768. Various hand held devices having cylindrical shaped handles for receiving fingers have also been described. See e.g. US Patent App. No. 2011/0016734 A1, U.S. Pat. Nos. 6,018,877 and 6,112,421. Convenience and space saving hand held devices have also been described. See e.g. US Patent App. No. 2011/0088268 A1 describing a hand held device with an articulated handle extension having an adjustable length. WO 97/25189 also describes a hand held device with two hand held device heads attached to a flat oval shaped handle. See also, U.S. Patent Publication No. 2012/0042478. Further, storage of various forms of compact hand held devices within containers have also been described. See e.g., U.S. Pat. No. 1,234,834.

Despite the handles which have been described, there remains a need for a handle which has a gripping portion made of a component which can easily be changed and is preferably flexible and elastic but allow users to have a portable handle which is ergonomic and user friendly but still provide the responsiveness needed to control the device head unit.

### SUMMARY OF THE INVENTION

One aspect of the invention provides for a hand held device comprising: a head unit, such as for a toothbrush or razor; and a handle comprising a docking member for connecting to said head unit, and a gripping portion positioned distally away from and said docking member, wherein said gripping portion comprises: a substrate retaining member forming a receiving region; a substrate fixedly or removably retained by said retaining member in said receiving region, said substrate comprising an elastomeric material, and forming a first finger receiving region and second finger receiving region, on the opposing side of said substrate.

Another aspect provides for a handle comprising a docking member and a gripping portion, wherein said gripping portion is positioned distally away from and said docking member, wherein said docking member connects to said head unit, and wherein gripping portion consists essentially of: a substrate retaining member forming at least a partial ring forming a receiving region; a elastomeric substrate is retained within said receiving region, said elastomeric substrate is a unitary body comprising a first finger receiving region and second finger receiving region, on the opposing side of said substrate. In one preferred embodiment the elastomeric substrate can be shaped like a disc or coin and inserted into the receiving region such when handled by a user, the user's fingers are guided to apply opposing pressure onto the two large flat surfaces of the substrate.

Yet another embodiment provides for a method of changing the substrate a handle as described herein comprising the steps of: obtaining a handle in accordance to the present invention; removing said substrate currently retained in the handle; obtaining a second substrate which can be the same or different from the substrate which has been removed; retaining said second substrate into the substrate retaining region. Importantly, this process can be done by the manufacturer, a service provider, or the consumer themselves. In such a situation, it may be useful to sell refills of the substrate, or provide multiple substrates to the consumer when they purchase the device.

### BRIEF DESCRIPTION OF THE DRAWINGS

FIG. 1 is a side perspective view of a device according to at least one embodiment of the invention wherein various parts of the device are shown detached.

FIGS. 2a-2e show various planar views of a device according to at least one embodiment of the present invention.

FIG. 3a shows top view of a device where a retaining member is formed into said handle.

FIGS. 3b and 3c show an elastomeric substrate suitable for insertion into the handle shown in FIG. 3a.

FIG. 4 shows two dimensional views of various shapes which can be used for the elastomeric substrate of the present invention.

FIGS. 5a and 5b are top planar views of two additional devices in accordance with the present invention.

FIG. 6 shows a handle where the gripping portion forms a retaining member which merely forms a partial ring for retaining a substrate.

FIGS. 7a and 7b are side views of two other devices in accordance with the present invention.

FIGS. 8a and 8b show another embodiment in accordance with the invention.

FIGS. 9a and 9b show side views of yet another embodiment in accordance with the invention.

FIG. 10a and FIG. 10b show two perspective views of a razor in accordance with the present invention within an enclosable case.

### DETAILED DESCRIPTION OF THE INVENTION

The present invention relates to a hand held device, such as a hair removal device, shaving razor, or a toothbrush, a drawing or cosmetic utensil, more preferably a shaving razor, wherein the hand held device comprises a head unit and a handle. The handle comprises docking member for permanently or removably connecting to the head unit, and a gripping portion, wherein said gripping portion and said docking member are positioned distally away from one another, wherein said docking member permanently or detachably connects to said head unit base, and wherein said gripping portion fixedly or releasably retains at least one substrate therein.

The gripping portion forms a substrate retaining member forming a substrate receiving region which can be an enclosed aperture or an open receiving region which is adapted to retain a substrate. Preferably the substrate is an elastomeric substrate but it could also be designed such that the substrate has a rigid core and has elastomeric material layered on one or both sides. In one embodiment, the retaining member is a partial or full peripheral ring forming at least one aperture. Fixedly or releasably retained within said substrate receiving region is a substrate. In one embodiment the substrate comprises an elastomeric material, such as a elastomeric coating, 12758 4 in another embodiment, the substrate consists essentially of elastomer and forms a unitary body made of said elastomeric material.

The substrate comprises a first (top) surface forming a first finger receiving region and a second (bottom) surface forming a second finger receiving region, wherein the first surface is on the opposite side of the substrate than the second surface. In use the first finger receiving region can be contacted by the thumb while the second finger receiving region is contacted by one or both of the index and middle fingers. Or vice versa where the thumb is on the second finger receiving region and so forth.

The substrate is fixedly or removably attached to said substrate retaining member. This is particularly useful as it allows for added flexibility in manufacture by making the portion of the handle which is the primary gripping portion component driven such that the substrate can be changed if the manufacture desires a stiffer or softer handle. The component nature of this substrate also allows for modifications based on consumer preferences without need to change the rest of the handle; for example, by changing the materials in the substrate, or adding a surface treatment, the rest of the gripping portion can remain the same (such as the retaining member), but the handle can look and perform very differently. It may also be useful to allow consumers to change the substrate themselves based on their usage needs. For example, if a user tends to use the device in a wet of soapy environment, he or she may want a substrate that has enhanced grip. If, however, the user prefers a smoother look and finish, they could obtain a substrate which is metallic or chromed in appearance.

Where the substrate is an elastomeric substrate, it can provide particularly desirable user feel and response. Without intending to be bound by theory, it is believed that hand held devices which are used in such a way allows the handle to react to forces applied by the user in an adaptive and responsive way with the elastomeric material provides for dynamic resistance to forces applied by the opposing fingers. In effect, the elastomeric substrate is a moving and flexible membrane which allows the user to apply force to the device but still has some elastic give and flexibility.

One important benefit of having the body portion of the handle consist of the elastomeric substrate, as opposed to mere layers of elastomer coating on the surface of a rigid handle, is that the elastomeric material provides a softer feel allowing for a sense of feeling through the entire thickness of the handle. Some of the performance improvements related to having an elastomeric substrate forming the first and second finger receiving regions is that the user has enhanced control over the handle while maintaining comfort during use from the soft, pliable nature of the elastomers. Further since the elastomeric substrate is pliable, the user can apply force in different regions or angles onto the elastomeric substrate but it will naturally contour based on how the head unit contacts the body. The elastomeric substrate can also, provides enhanced grip due to any surface treatments which can be applied onto the elastomeric material,

### 1. Head Unit

The head unit can be a toothbrush, a writing or cosmetic utensil such as a pen or pencil, or a wide scraping surface such as for hair removal. Nonlimiting examples of hair removal device include those used with a depilatory or for skin exfoliation, or razors with a blade unit, such as a safety razor. Where the hair removal head is a razor cartridge razor may be power or manual, disposable or a refillable system. The razor cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a shaving aid. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288, and U.S. Patent Publ. 2008/060201. The head unit can also be a brush or a toothbrush, such as shown in FIG. 6b where bristles extend away from the head unit.

The terms “forward” and “aft”, as used herein, define relative position between features of the blade unit (i.e., razor cartridge). A feature “forward” of the at least one blade, for example, is positioned so that the surface to be treated with by the device encounters the feature before it encounters the at least one blade. For example, if the device is being stroked in its intended cutting direction, the guard is forward of the blade(s). A feature “aft” of the blade(s) is positioned so that the surface to be treated by the device encounters the feature after it encounters the blade(s), for example if the device is stroked in its intended cutting direction, the cap is disposed aft of the blade(s).

In one embodiment, the head unit is a razor cartridge comprising one or more blades, and a guard positioned forward of said one or more blades, wherein the guard has at least one elongated flexible protrusions to engage a user's skin. In one embodiment, at least one flexible protrusions comprises flexible fins generally parallel to said one or more elongated edges. In another embodiment, said at least one flexible protrusions comprises flexible fins comprises at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having guard forming at least one passage extending between an upper surface and a lower surface).

In one embodiment, the head unit comprises at least one skin engaging member such as a conventional shave aid or lubrication strip. The skin engaging member can be positioned forward and/or aft of any blade(s). Non-limiting examples of known skin conditioning compositions suitable for use herein include shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and 2009/0223057.

The head unit is fixedly or removably attached to a handle. The attachment can be a direct attachment from head unit to a docking member of the handle, or the head unit can attach to an interconnect member which is then connected to the docking member of the handle.

### 2. Handle

a. Gripping Portion

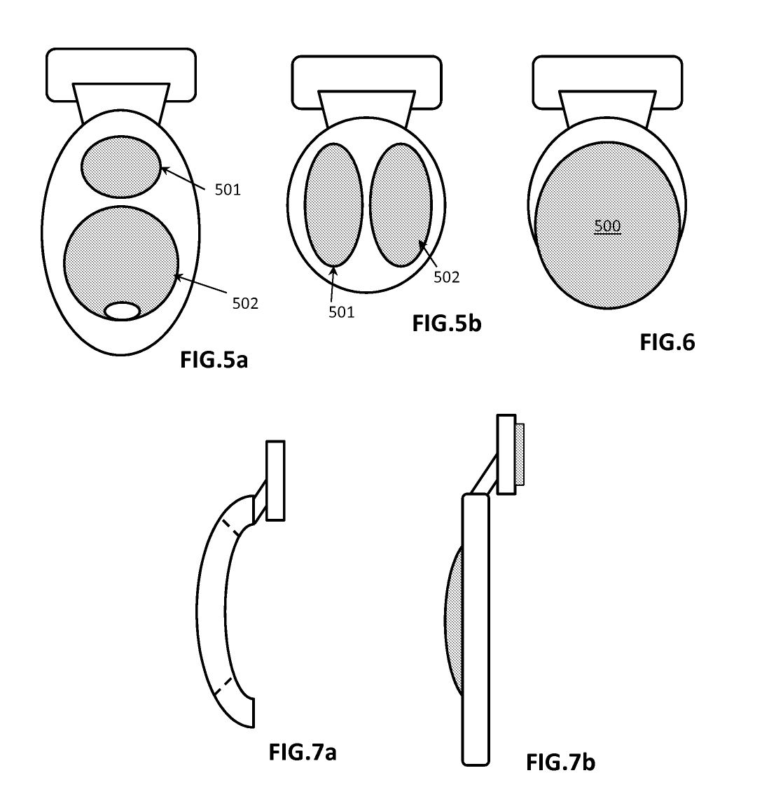

The handle comprises a docking member and a gripping portion, wherein said gripping portion is positioned distally away from and said docking member, wherein said docking member connects to said head unit. The gripping portion comprise a substrate retaining member which forms at least one receiving region. In one embodiment, the substrate retaining member forms a ring which defines an aperture, suitable for retaining one or more substrates. The retaining member need not form a full ring yet still be able to retain a substrate. Also, the retaining member could form a full ring but not wrap around the entire periphery of the substrate (i.e. the retaining member can define a perfectly circular ring, while the substrate forms a half circle, or other void space where a through hole or other passage can be defined). See e.g. FIG. 5a, substrate 502 which defines a void space or through hole such that the substrate retaining member, which is in this case a ring, fails to wrap around the entire periphery of the substrate. In other embodiments, one or more voids or through holes can be formed in various regions of the elastomeric substrate to allow for water passage, or for different ergonomic response and feel during use.

In certain instances, such as where the substrate is more rigid, the retaining member could merely attach to a portion of the substrate such as by adhesive or a mechanical attachment without forming a fully connected ring.

In one embodiment, a portion of the substrate retaining member can be coated with an elastomeric grip material. This can be useful if users desire the entire gripping portion to have an elastomeric feel. In one embodiment, the entire exterior surface (the surface not contacting the docking member or the elastomeric substrate) of the gripping portion or the exterior surface of the retaining member is coated with one or more elastomer grip materials. These elastomeric grip materials are known in the art and include many of the elastomeric materials described for used in the elastomeric substrate. They can be the same or different than those used in the substrate.

The gripping portion can have many different shapes, including but not limited to a flat rounded disk shape where the retaining member retains a round coin shaped substrate. The substrate can be removably or fixedly retained in the retaining member. In one embodiment, the substrate is an elastomeric substrate and can be molded or otherwise cast directly into the retaining member or peripheral ring. Alternatively, the substrate can be formed in a separate step, then fitted into the aperture. Various forms of retaining the substrate can be used. If a removable embodiment is desired, the substrate can be force fitted into the aperture, such as with a tongue and groove fitment along a portion or the entire retaining member, one or more pin and receiving holes, such as where the retaining member includes one or more pins projecting into corresponding receiving holes formed in the substrate. Various ways to fixedly retain the elastomeric substrate onto the substrate retaining member are possible, such as, but not limited to, use of adhesives, or thermal bonding.

b. Elastomeric Substrate

In one embodiment, the substrate comprises or is made primarily of elastomeric material, referred to herein as an elastomeric substrate. The elastomeric substrate of the present invention is retained within said substrate receiving region or aperture. The elastomeric substrate is a generally wide and flat structure which could be in the form of a disc or coin shape. The elastomeric substrate comprises a first surface forming a first finger receiving region and a second surface forming a second finger receiving region.

In one embodiment, the elastomeric substrate is removable and or replaceable. With replaceable elastomeric substrates, the consumer can select from different surface treatments or colors depending on their need. For example, if the user desires a smoother finish with lower friction, they can select an elastomeric substrate with a smooth finish. Correspondingly, if the user desires something with more friction and easier to grip, such as when used in a wet environment, they can select an elastomeric grip with more embossments or surface treatments to increase friction. The hardness of the elastomeric substrate can also be varied so the user can pick their desired firmness and feel. Further, the user can replace the substrate if it becomes dirty or otherwise worn from use.

In one embodiment the substrate is easily removable from the retaining member, such as where it is slide in place and only requires a minor amount of force to separate and remove. In another embodiment, the elastomeric substrate is fixedly attached to the substrate such that it is not readily removable by the consumer but can be removed such as a force fit or tongue and groove fitment. In another embodiment, the substrate is permanently attached to said retaining member such as by heat bonding or adhesives.

In one embodiment the elastomeric substrate is a unitary body. Unitary body, as defined herein, means that the elastomeric substrate is a self supported structure which does not include a supporting beam or internal structure such as other handles where an elastomeric grip material is layered over a rigid handle. The unitary body need not be made of one single material, and can have multiple layers but should be made entire of elastomeric materials such that if sufficient force is applied to one surface the unitary body can wholly deform and flex on the opposite side. In effect, aside from any portion of the retaining member which attaches to the elastomeric substrate, the handle need little to no additional rigid material necessary. The elastomeric nature of the substrate allows the handle to deform yet still allow the user control over the head unit with desirable ergonomic feel during use.

In one embodiment, the elastomeric substrate comprises more than one layer of elastomeric material. This can be particularly useful as different materials can have different elasticity and hardness. The multiple layers can be of the same material or of different materials. In one embodiment a stiffer material is used in a central layer with softer and/or more elastic materials used in the layer(s) forming the first and/or second finger receiving regions. One or more coatings can also be applied over the elastomeric substrate such as to provide specific surface finish or textures or colors. In one embodiment, the elastomeric substrate comprises a single layer.

Non-limiting examples of suitable materials which can be used as the elastomeric substrate include natural and synthetic rubbers, polymers such as high impact polystyrene (HIPS), polypropylene (PP) and acrylonitrile butadiene styrene (ABS), elastomers, and mixtures thereof.

Suitable elastomeric materials include an elastomer or blend of elastomers. Elastomers suitable for use in gripping areas 14 are well known in the razor and toothbrush art. Generally, the elastomeric material includes one or more thermoplastic elastomers (TPEs). Suitable TPEs include thermoplastic vulcanates (rubber polyolefin blends), polyetheramides, polyesters, styrene-ethylene-butylene-styrene (SEBS) block copolymers, styrene-butadiene-styrene block copolymers, partially or fully hydrogenated styrene-butadiene-styrene block copolymers, styrene-isoprene-styrene block copolymers, partially or fully hydrogenated styrene-isoprene-styrene block copolymers, polyurethanes, polyolefin plastomers, polyolefin plastomers, styrenic based polyolefin elastomers, compatible mixtures thereof, and similar thermoplastic elastomers. Preferred TPEs include styrene-ethylene-butylene-styrene (SEBS) block copolymers, styrene-butadiene-styrene block copolymers, partially or fully hydrogenated styrene-butadiene-styrene block copolymers, styrene-isoprene-styrene block copolymers, and partially or fully hydrogenated styrene-isoprene-styrene block copolymers, commercially available from Shell under the tradename KRATON rubber. Particularly preferred are styrene-ethylene-butylene-styrene (SEBS) block copolymers available from Shell under the tradename “G-Type” KRATON rubbers. The aforementioned TPEs may be modified with fillers such as talc, and with oil, which will generally reduce the hardness of the elastomer, as is well known in the art. Other suitable elastomers include resilient urethanes and silicones. Elastomers may be available from Arkema Inc., Philadelphia, Pa. (e.g., Pebax® 2533); E.I. DuPont de Nemours & Co., Wilmington, Del. (e.g., Zytel® 2158L); Kraton Polymers U.S. LLC, Houston, Tex.; and Kraiburg TPE Corp., Duluth, Ga. (e.g. Kraiburg HTC8858).

In one embodiment, the elastomeric substrate comprises a compressible thermoplastic elastomeric material which is moldable. Suitable thermoplastic elastomeric materials are block copolymers comprising styrene, ethylene, and butylene. Representative useful thermoplastic elastomers include commercially available polyolefin thermoplastic elastomeric polymers such as those sold under the tradenames “SOMEL” by E.I. DuPont de Nemours & Co. or “TELCAR” by B.F. Goodrich Co. or “PROFAX” by Hercules Inc. Block copolymers such as styrene-butadiene-styrene copolymers sold under the tradename KRATON D by Shell Chemical Co. or styrene-ethylene/butylene-styrene copolymers sold under the tradename KRATON G by Shell Chemical Co. are especially preferred. Other representative suitable thermoplastic elastomers include polyester and polyurethane thermoplastic elastomers.

In one embodiment, the elastomeric material can have a compressibility index (CI) value between about 1000 to about 18,000 gm/cm. The compressibility index (CI) is defined as the slope of the force/compression distance curve at a distance of compression of 0.025 cm. as measured in accordance with the procedure described later. The CI value has been derived from extensive consumer test data involving test subject responses to numerous commercial and experimental finger gripping devices. The consumer test data was analyzed and evaluated to determine if some common factor or factors existed which could be used to reliably predict test subject's favorable ratings and acceptance for a given finger gripping device. Interpretation of the data indicated that favorable test subject response to a given device appeared to be primarily dependent on the combination of the softness and compressibility and resiliency properties provided by the tested device. These properties, in turn, are dependent on the combination of the compressible material and configuration selected to provide the device. In accordance with our invention, we have found that a close correlation exists between CI value and the test subjects' perception of increased comfort and decreased fatigue in use of the device.

In one embodiment, the thermoplastic elastomer is polar and hydrophobic. The thermoplastic elastomer can have a coefficient of friction of in a range of about 2.0 to about 3.5 when wet with water, a tack force of about 3 g to about 12 g when dry, and/or a Shore A hardness of about 35 to about 50. Hardness of materials is tested at room temperature and at 36 degrees Celsius using Shore A Durometer Instron Model 9130-35 (available from Instron, Norwood, Massachusetts) according to ASTM 2240-00. Friction and tack measurements can be conducted in accordance with the methods described in U.S. Patent Publication No. 2012/0167401. The thermoplastic elastomer can also be used with additives, fillers, and/or rubber mixtures or modifiers. Suitable composite structures, additives, and/or fillers are described in U.S. Pat. No. 3,972,528. For examples, additives may be one or more of the following additives: paraffinic white oils, inorganic bulking agents, ether ester plasticizers, sulfurized mineral oil, alkenyl amide, styrol, polystyrol, petrolatum, polyisobutylene, polybutene, styrene, elastomeric styrene, ethylene, butylene, aqueous carboxylated synthetic polymer having a minimum film-forming temperature (MFFT) (e.g., 10 degrees Celsius or below), low MFFT synthetic polymer reinforced during manufacturing by co-agglomeration with polystyrene, combinations thereof, or any other suitable additive to achieve an elastomeric substrate that has a high coefficient of friction when wet and low tack when dry.

The elastomeric material can include a styrenic block copolymer, e.g., styrene-ethylene-butylene-styrene (SEBS). Additional examples of potentially suitable elastomeric materials are disclosed in U.S. Pat. Nos. 4,932,800, 7,160,508, 5,314,940, 5,670,263, 6,610,382, and 6,904,615, U.S. Patent Application Publication Nos. 2002/0114920, 2011/0143112 and U.S. Patent Publication No. 2012/0167401.

Depending on the type of elastomeric material used, it may be desirable to add some rigidity to the substrate. In one embodiment, the handle further comprises one or more support beams running through the substrate receiving region. The support beams can be rigid like the material used to form the substrate retaining member. Those of skill in the art will appreciate, however, that stiffer elastomeric materials can also be chosen if the users prefer a stiffer feel.

In one embodiment, the one or more support beams is connected to two regions of the retaining member. In one embodiment, the one or more support beams forms a diameter running through the central region of the substrate receiving region. In one embodiment, the at least one support beam is fully encased within said elastomeric substrate such that no portion of the support beam is exposed through the elastomeric material forming the substrate. As such, the support beam can provide structural support if a softer and more elastic substrate is used but still have the first and second finger receiving regions retain the desirable feel of the elastomeric material. Notably, the support beams are different from the known razors where the body of the handle is primarily rigid and an external elastomer or grip coating is applied. The support beam, if used in the present invention, should make up no more than 50% by weight of the elastomeric substrate, preferably less than about 40%, preferably less than about 25%, preferably less than 10%, and in many instances is not needed.

In one embodiment, the support beam forms a central spine within said elastomeric substrate. Central spine, as defined herein means that the support beam generally passes through or near the center of gravity of the fully assembled device, with a head unit attached. Multiple support beams (parallel or not) can also be used). In another embodiment, the elastomeric substrate retains its structural integrity without a need for any support beams. The elastomeric substrate, as explained before, can be one or more layers of elastomeric material. Preferably, force applied by a user on one finger receiving surface can in some humanly detectable manner be sensed on the opposing finger receiving surface while the device remains stationary.

c. Other Substrate Details

The substrate can also include an antimicrobial agent. If present, the antimicrobial agent can include an isothiazolinone. The antimicrobial agent is thermally stable. The antimicrobial agent is present in a concentration of at least 500 ppm, preferably from about 700 to 2000 ppm. The antimicrobial agent has a minimum inhibitory concentration of less than 100 ppm. The antimicrobial agent includes 4,5-dichloro-2-n-octyl-4-isothiazolin-3-one. The antimicrobial agent exhibits both antifungal and antibacterial properties. Examples of specific antimicrobial agents include: e.g., 4,5-dichloro-2-n-octyl-4-isothiazolin-3-one (CnH17CL2NOS; CAS Registration No. 64359-81-5). Isothiazolinones are commercially available, e.g., from Rohm & Haas Company. 4,5-dichloro-2-n-octyl-4-isothiazolin-3-one has an MIC of about 50 ppm, a molecular weight of 282.2, and is thermally stable. These and other antimicrobial agents are known and include those described in U.S. Pat. No. 7,160,508.

In one embodiment, the substrate is substantially flat. The substrate can also be domed such that the bottom surface forms a concave depression, the top surface forms a convex shape, or where both the top and the bottom surfaces are concave shaped such that they taper inwards towards the center of the substrate. The top and bottom surfaces could also both be convex shaped such that they form a bulbous substrate where the substrate is thicker towards the center portion and thinner about the periphery.

In one embodiment, the handle or a portion thereof (such as just the elastomeric substrate) can be coated with or comprise a thermochromic material such as shown and described in U.S. Pat. No. 6,868,610. This can be particularly pleasing to consumers who like to see aesthetic changes when they handle the razor, particularly one where the handle has an elastomeric substrate as presently described.

One embodiment of the present invention provides for a method of replacing or changing the substrate from an already assembled handle. The method comprises a step of obtaining a handle in accordance to the present invention; removing said substrate currently retained in the handle; obtaining a second substrate which can be the same or different from the substrate which has been removed; retaining said second substrate into the substrate retaining region. Importantly, this process can be done by the manufacturer, a service provider, or the consumer themselves. In such a situation, it may be useful to sell refills of the substrate, or provide multiple substrates to the consumer when they purchase the device. The handle can be sold fully assembled with a substrate retained therein, or can be sold in component manner so the user can assemble the handle by retaining the substrate into the substrate retaining member.

The device can also be marketed in various combinations, i.e. one handle with one head unit and one substrate, kits with multiple head units, multiple substrates, or multiple handles can be provided. In one embodiment, the kit consists of one assembled device, refills on the head unit, and/or replacement substrates.

### 3. Device Dimensions

Unlike existing razor and toothbrush handles currently on the market, the handle of the present device is relatively small and not a long stick like shape. Without intending to be bound by theory, it is believed that having a shorter handle allows for more dexterity when handling the device. In effect, the center of gravity is closer to the head unit, with a more even distribution of weight. Improved ergonomics and handl-ability can also be helped with the actual shape of the gripping portion of the handle. Non-limiting examples of suitable shapes are disclosed herein.

In one embodiment, the device is a razor such that the shortest distance from a razor blade on the head unit to the furthest portion of said handle is less than about twice the maximum width of said head unit, preferably less than about 1.5 times, preferably less than 1.25 times. Having a razor with a relatively short handle compared to the cartridge width can be preferable to some users for ergonomics, design, ease of handling or storage, and so forth. In another embodiment, the greatest length of the handle (without the head unit attached) is less than or equal to the maximum width of the head unit, or from 2:1 to 1:1, preferably from 1.75:1 to 1.5:1. Specific ratios of suitable dimensions are shown in the Figures.

### 4. Enclosable Case

In one embodiment, a container case is also provided for storing the device. The container case can be open, such as a razor tray or holder, or more preferably is enclosable so the device can be stored within a container. In one embodiment, the enclosable case comprises at least one aperture to allow air to pass between the interior and exterior of the case. This can be particularly useful if the device needs to dry between uses. Those of skill in the art will understand that where the device is a toothbrush or razor, it may be desirable to allow the device to dry to avoid bacterial or fungal growth, malodors, adverse affects on chemical components, such as the lubrication aids, and so forth. As such, in one embodiment, the enclosable case comprises one or more apertures positioned in a discrete area or uniformly throughout the case to allow moisture and water to evaporate and exit the interior of the case.

The enclosable case can be have a cap and tray which may be attached or detached. If attached, they cap and tray can be hinged or slidably mounted. If detached, the cap can be closed onto the tray like a box top. Various forms of enclosable cases are known and can be modified to contain the device described herein. Other forms of attaching the cap and tray are also within the scope of this invention. In one embodiment, the enclosed case includes a retention mechanism that helps the case stay closed when in a closed orientation. The retention mechanism can be a tongue and groove fitment, magnets, a latching hook, a snap fit or pressure fit closure, and so forth. The enclosable case could also be biased to stay in a closed position when not opened by the user such as by spring biasing members or magnets.

### 5. Figures

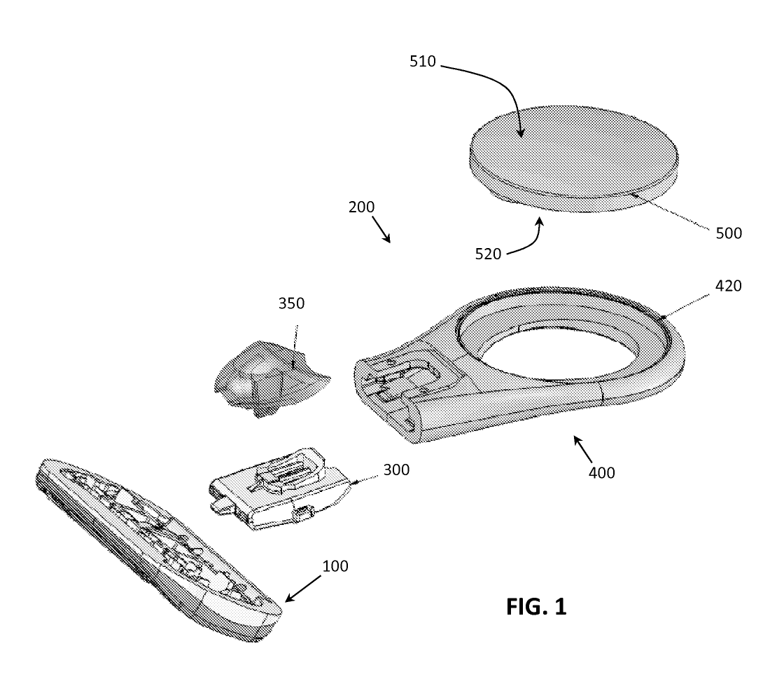

FIG. 1 exemplifies a disassembled hand held device in accordance to at least one embodiment of the present invention. The hand held device comprises a head unit (100) removably attached to a handle (200) shown with components detached. The handle comprises a docking member (300) with an release member (350) to allow releasing of the head unit. Similar docking members are known and used on various refillable razor handles. The handle also comprises a gripping portion (400) which is designed to be the first region where the user will hold the device. Those of skill in the art will of course understand that users could also hold other regions of the device based on individual preference. The gripping portion (400) comprises a substrate retaining member (420), shown here as a peripheral ring, functionally attached to the docking member such that the docking member removably of fixedly attached to the gripping portion of the handle. The retaining member forms at least one receiving region, shown here as an aperture which retains a substrate (500) having a first surface (510) forming a first finger receiving region and a second surface (520) forming a second finger receiving region. The first surface and the second surface are on opposing sides of the elastomeric substrate, in one embodiment the first surface forms the top of the handle and the second surface forms the bottom when the assembled device has the head unit facing down. As explained above, the substrate can be rigid or be an elastomeric substrate. Those of skill in the art will understand that various other head units can be attached to the same handle, including but not limited to toothbrushes, minors, cosmetics applicators and so forth.

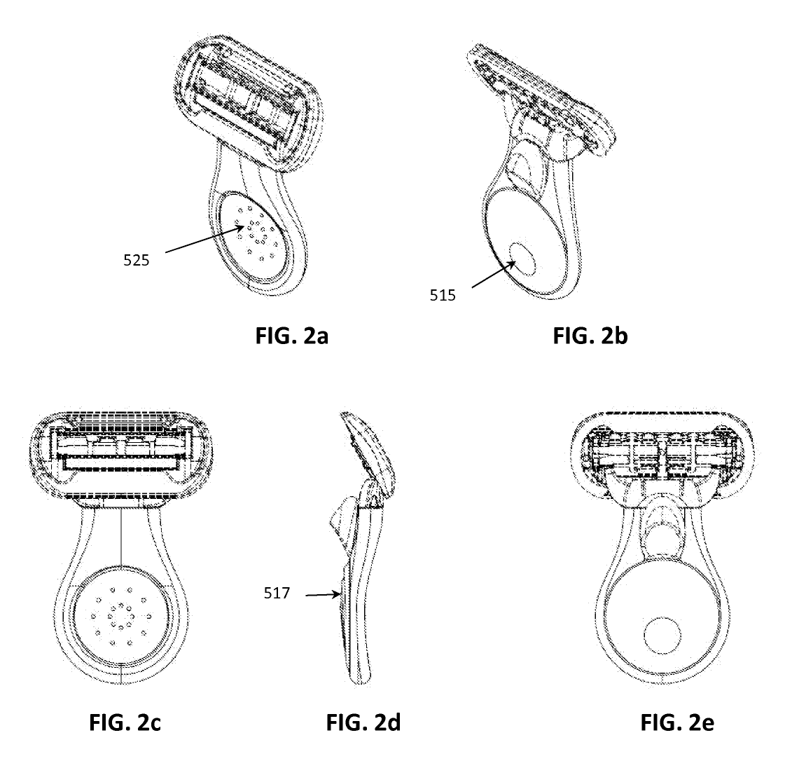

FIGS. 2a-e shows various angles of a fully assembled hand held device in accordance with at least one embodiment of the present invention. As shown here, the substrate can have various forms of surface treatments including nubs as shown in the second surface (525) or a finger orienting guide (515). Apertures, embossments, depressions, blind holes, or various other surface treatments can also be formed into one or more surfaces of the substrate based on what would provide the user with improved feel or control, particularly if the handle were wetted or made slippery by soap or other chemicals during use. FIG. 2A is a perspective view of the bottom of the device, while 2b is a perspective view of the top. FIG. 2c is a planar bottom view and FIG. 2d shows a side view of the device with topographical changes on the first surface. In one embodiment, one or more of the substrate surfaces can be smooth or have a layered surface. FIG. 2e is a top view.

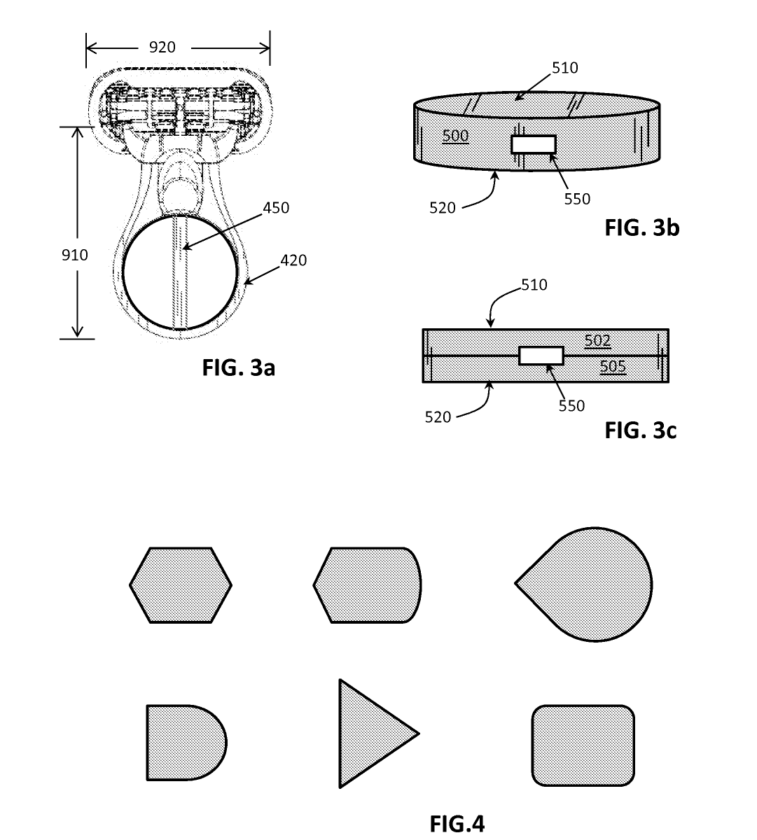

FIG. 3a shows top view of a device according to at least one embodiment of the present invention wherein the substrate is removed (such as those shown in FIG. 3b or 3c). FIG. 3z shows a support beam (450) passing through the aperture in a manner generally parallel with the major axis of the handle. Other orientations are also within the scope of the invention. At least one end of the support beam is attached to the retaining member (shown here as a peripheral ring) (420), in this embodiment, both ends are attached to said ring. Also shown is the head unit width (920) and the distance from the blade closest to the handle to the opposing end of the handle. If the head unit does not include a blade, this latter distance can be measured as the maximum length of the handle from tip of docking member to opposing end of the handle. FIG. 3b shows a detached substrate suitable for use with the handle shown in FIG. 3a. An aperture (550) is shown where the support beam would be present. To assemble the member in this situation, it may be useful to mold the substrate into the gripping portion so the substrate is formed around the support beam. Alternatively, FIG. 3c shows a 2 layer substrate with a first layer (502) and a second layer (505). The substrates shown in FIGS. 3-9 are lightly shaded for visibility in contrast to the retaining member of the handle.

As shown, the gripping portion of the handle forms a generally circular shape. The gripping portion can also form other shapes such as 2-dimensional arcoidal shape selected from the group consisting of a circle, oval, or a semi-circle.

FIG. 4 shows two dimensional views of various shapes which can be used for the substrate and/or the gripping portion.

FIGS. 5a and 5b are top planar views of two additional devices in accordance with the present invention. These devices are shown where the peripheral ring forms more than one aperture and one or more substrates (501) and (501) which are retained in said apertures. The substrates can be made of the same material or different and can have same or different surface treatments. If the substrate is formed by pouring and molding directly into the peripheral ring, the apertures can be connected via a channel. Thus, the substrates can be poured into a first aperture and flow into both apertures filling them with the same composition, if desired.

FIG. 6 shows a top view of yet another device in accordance with the present invention. This device comprises a handle comprising a docking member and a gripping portion, wherein said gripping portion is positioned distally away from and said docking member, wherein said docking member connects to said head unit, and wherein gripping portion comprises: a retaining member forming at least a partial ring forming a substrate receiving region, which is also referred to in other embodiments as the aperture; a substrate (500) retained within said receiving region. The substrate can be an elastomeric substrate being a unitary body forming a first surface forming a first finger receiving region and a second surface forming a second finger receiving region. The elastomeric member can be arcoidally shaped, such as in the form of a disc. Those of skill in the art will understand that disc need not be perfectly cylindrical as long as the substrate is generally rounded and retained in receiving region formed in the retaining member during use and is easily gripped by hand. FIGS. 7a and 7b are side views of two other devices in accordance with the present invention. FIG. 6a shows a device where the handle is curved with the substrate having a similar curve shape. FIG. 7b shows the handle generally flat with a curved substrate. Those of skill in the art will understand that the curves, though shown as concave if you are looking down on the top surface, can also be made concave when viewed from the same view point. The head unit of the device of FIG. 7b is shown with a substrate, bristles, or sponge on the head unit.

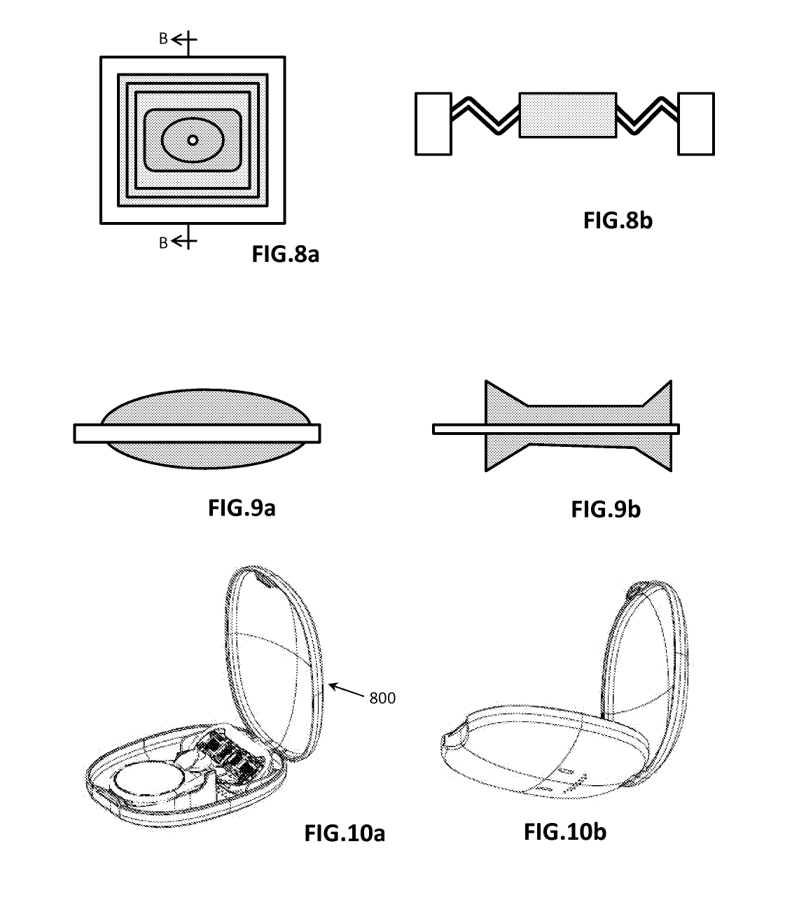

FIGS. 8a and 8b show another embodiment in accordance with the invention. Here the substrate may have a generally flat region (as shown in the center) with additional elastomeric material providing flexing support or membrane between the flat region and the peripheral ring. These flexing membranes are similar to speaker cone where a central element is suspended by a membrane connecting to a peripheral rigid structure. In this case, the central element could be the portion of the substrate designed for gripping by the fingers, around this portion can be the flexing membrane which can be chosen elastomeric and flexible in nature. Similar flexing materials are shown in WO 2012/157624 where a flexible membrane is shown suspending a razor cartridge.

FIGS. 9a and 9b are side views of other handles in accordance with the present invention. In FIG. 9a, the elastomeric member is shown bellowing out away from the center of the handle. In FIG. 9b, the elastomeric member deforms inwards. Combinations of concave and convex formations can also used (i.e. where both surfaces deform in similar shape as shown in FIG. 6a).

FIG. 10a shows a top perspective views of a razor in accordance with the present invention within an enclosable case (800) having a receiving portion which contains a razor and a hinged lid. FIG. 10b shows a bottom view of the same enclosable case with a set of apertures formed in the receiving portion of the case which stores the razor.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. All measurements are performed at 25° C., unless otherwise specified.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern. Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1) A hand held device comprising:
a. a head unit; and
b. a handle comprising a docking member for connecting to said head unit, and a gripping portion positioned distally away from and said docking member, wherein said gripping portion comprises:
i. a substrate retaining member forming a receiving region;
ii. a substrate removably retained by said substrate retaining member in said receiving region, said substrate comprising a first finger receiving region and second finger receiving region, on the opposing side of said substrate.

2) The hand held device of claim 1, wherein said substrate retaining member is a ring forming at least one aperture.

3) The hand held device of claim 1, wherein said substrate retaining member wraps around the entire periphery of said elastomeric substrate.

4) The hand held device of claim 1, wherein the handle comprises at least one support beam running through at least a portion of said elastomeric substrate.

5) The hand held device of claim 1, wherein said gripping portion forms a 2-dimensional arcoidal shape selected from the group consisting of a circle, oval, or a semi-circle.

6) The hand held device of claim 1, wherein said substrate is fixedly attached to said retaining member.

7) The hand held device of claim 1, wherein said substrate is an elastomeric substrate comprising at least one of a high impact polystyrene, polypropylene, and acrylonitrile butadiene styrene, a thermoplastic elastomer, and a mixture thereof.

8) The hand held device of claim 1, wherein a portion of said retaining member is coated with an elastomeric grip material.

9) The hand held device of claim 1, wherein a portion of said handle comprises a thermochromic material.

10) The hand held device of claim 1, wherein said elastomeric substrate further comprises an antimicrobial agent.

11) A hand held device for shaving comprising:
c. a razor cartridge; and
d. a handle comprising a docking member and a gripping portion, wherein said gripping portion is positioned distally away from and said docking member, wherein said docking member connects to said head unit, and wherein gripping portion consists essentially of:
i. a retaining member forming at least a partial ring forming a receiving region;
ii. an elastomeric substrate retained within said receiving region, said elastomeric substrate being a unitary body; and
iii. said elastomeric substrate comprising a first finger receiving region and second finger receiving region, on the opposing side of said substrate.

12) The hand held device of claim 11, wherein said unitary body comprises more than one layer of elastomeric material.

13) The hand held device of claim 11, wherein said retaining member forms a peripheral ring around at least one elastomeric substrate.

14) The hand held device of claim 11, wherein said retaining member forms two apertures, each aperture retaining an elastomeric substrate.

15) The hand held device of claim 14, wherein each of said elastomeric substrates are formed of different materials.

16) The hand held device of claim 14, wherein said elastomeric substrates have different surface finishes on at least one of said first finger receiving regions or second finger receiving regions.

17) A method of changing a handle comprising:
a. obtaining a handle in accordance to the device of claim 1;
b. removing said substrate;
c. obtaining a second substrate;
d. retaining said second substrate into the substrate retaining region.
